(19) United States
(12) Patent Application Publication
(10) Pub. No.: US 2010/0110923 A1
(43) Pub. Date: May 6, 2010

(54) METHOD OF OPERATING A TELECOMMUNICATIONS NETWORK

(76) Inventors: Paul Marrow, Ipswich (GB); David Gowans, Ipswich (GB); Richard E. Tateson, Brundish (GB); Mark A. Shackleton, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 12/593,784

(22) PCT Filed: Mar. 31, 2008
(86) PCT No.: PCT/GB2008/001124

§ 371 Date: Sep. 29, 2009

(30) Foreign Application Priority Data
Mar. 29, 2007 (GB) 0706149.2

(51) Int. Cl. H04L 12/56; H04L 12/26

(52) U.S. Cl. 370/252; 370/401

(57) ABSTRACT

In a method of operating a data network comprising a plurality of interconnected nodes (30) each of which is operable to perform one or more services upon receiving a suitable request for a service, one or more user devices (10) connected to the network can issue requests (12,14) for a service to be carried out by a node or nodes within the network. The method comprises: operating a virtual mechanism (50) in which a plurality of different types of elements (61,65,66,67) are represented, each element obeying a set of rules associated with the respective type of the element, the respective set of rules specifying how the element behaves, wherein each element has a location property which may be correlated to one or more nodes or node locations, the method further comprising analysing the virtual mechanism (50) and selecting one or more services to be offered by each node (30) in the network based on the analysis of the virtual mechanism.

### FIELD OF THE INVENTION

The present invention relates to a method of operating a telecommunications network and in particular to a method of using local interactions to match system resources within the network to demand.

### BACKGROUND TO THE INVENTION

As telecommunications networks grow in size, power and general complexity, keeping such a network operating in an efficient manner by human administration of the network becomes more and more difficult. For this reason, there is much ongoing research into the field of how such networks could operate autonomously, especially with regard to how to adjust the way in which the overall resources of the network are used in order to keep the network running as efficiently as possible.

In order to tackle this issue, one general approach is to assume that a network will offer users of the network various different services and that the efficiency of the network as a whole can be measured in terms of how successfully and quickly user requests for such services are satisfied by the network. Furthermore, it is assumed that the overall demand of a population of users may well vary with time in an unpredictable manner. Viewing the problem in this way has led to alternative proposals, by the present applicant, for operating a network which have been inspired by biological examples such as the manner in which colonies of bacteria adapt to changing environmental conditions.

### SUMMARY OF THE INVENTION

The method of the present invention is to employ a dynamic mechanism, hereinafter referred to as L-CID, which can help nodes in a network make good local decisions about which services they should offer.

We assume there is demand for services and we assume that nodes can take decisions about what services to offer. By using the actual demand to perturb the dynamics of our L-CID system, and by allowing the nodes to observe the current state of L-CID, the nodes can make better choices about which services to offer.

Thus, according to a first aspect of the present invention, there is provided a method of operating a data network comprising a plurality of interconnected nodes each of which is operable to perform one or more services upon receiving a suitable request, whereby one or more user devices connected to the network can issue task requests for a service to be carried out by a node or nodes within the network, the method comprising: operating a virtual mechanism in which a plurality of different types of elements are represented, each element obeying a set of probabilistic rules associated with the respective type of the element, the respective set of rules specifying how the element behaves (e.g. how it is created, destroyed, changed, moved and/or how it interacts with other elements etc.), wherein each element has a location property which may be correlated to one or more nodes or node locations, and analysing the virtual mechanism to determine the services to be offered by each node in the network.

The aspect of location is important because the idea is to enable nodes to make good local decisions; thus, in a preferred embodiment, each node has a corresponding virtual “local area” where elements can be located—and while elements are in that area, they have at least a chance of interacting with each other. Such interactions may result in elements changing state, or dying (i.e. being deleted) etc. Each node then preferably examines only it is own local “area” to determine what services it should be offering. A convenient way of implementing such an arrangement is to have each node responsible for running its portion of the distributed mechanism which is “local” to it, however, this is not strictly necessary however, in view of the virtual nature of the mechanism, it could in fact be run almost anywhere.

Analysing the virtual mechanism preferably includes determining some aspect of its current state, for example, the number of a certain type of element currently being located in its local area, etc. Preferably, for at least some of the elements, as well as belonging to a certain type which determines the set of rules used to govern its behaviour, each element also has a specificity which determines the particular type of service (offered—or offerable—by a node or nodes in the network) to which the element relates. Some such elements may be constrained by their governing set of rules to interact only with other elements of the same specificity.

Preferably, each node additionally performs actual services based on an analysis of the virtual mechanism. This may be achieved by arranging that when some types of elements interact or are created, etc. according to rules specifying the behaviour of elements, they cause a particular node (e.g. the node local to the area where interaction or creation, etc. occurred or at a Node explicitly specified within the created element, or one of the interacting elements, etc.) to carry out a particular service (preferably as detailed in the virtual element).

According to a second aspect of the present invention, there is provided a data network comprising a plurality of interconnected nodes each of which is operable to perform one or more services upon receiving a suitable request, wherein one or more user devices connected to the network are operable to issue task requests for a service to be carried out by a node or nodes within the network, the network further comprising an environment for running a virtual mechanism in which a plurality of different types of elements are represented, each element obeying a set of probabilistic rules associated with the respective type of the element, the respective set of rules specifying how the element behaves (e.g. how it is created, destroyed, changed, moved and/or how it interacts with other elements etc.), wherein each element has a location property which may be correlated to one or more nodes or node locations, and wherein the network is operable to analyse the virtual mechanism to determine the services to be offered by each node in the network.

Preferably, the environment for running the virtual mechanism is provided by the nodes themselves, in a distributed manner, in which each node runs a local portion of the overall environment, which portion has most influence over the resulting determination by the respective node of which services it should be offering. Preferably, each local environment portion includes interface means for permitting elements to be migrated from one local portion of the environment to another.

Further aspects of the present invention relate to a computer program or programs for carrying out the method of the present invention when executing on a standard computer or one or more devices forming nodes within a data network, and to carrier means, and most preferably to tangible carrier means such as a magnetic or optical storage disk or a non-volatile solid-state memory device, etc. carrying the program or programs or a device or devices programmed in accordance with the program or programs, etc.

### Inspiration

The method is inspired by the vertebrate immune system in which twin activations are needed to fully stimulate antibody production and memory. This requirement for two activating interactions acts to ‘damp’ the immune system so it responds with a long-term defense against genuine threats but does not over-react to every stray ‘antigen’.

### BRIEF DESCRIPTION OF THE DRAWINGS

In order that the present invention may be better understood, embodiments thereof will now be described, by way of example only, with reference to the accompanying drawings in which:

FIG. 1 is a schematic illustration of a single node in network operating in accordance with an embodiment of the present invention;

FIG. 2 is a flowchart of the lifecycle of a Request;

FIG. 3 is a state diagram illustrating how various elements of L-CID can interact with one another to cause state changes in the interacting elements leading to the creation of a job element; and

FIG. 4 is schematic illustration similar to FIG. 1 but showing two nodes and some interactions between the two nodes.

### DETAILED DESCRIPTION OF AN EMBODIMENT

### Application Scenario

We envisage this method proving useful as a service management mechanism in a distributed network services scenario. We imagine many nodes connected together into a network. Whatever the nature of the physical connections between nodes, which might or might not allow every node to connect to every other, we imagine that there will be an overlay network which defines a limited set of first-hop neighbours for each node.

Each of these nodes has:
a certain processing capacity
a list of services which it is able in principle to provide
a set of users who will make demands for services

### Terms:

node—a processing unit connected to neighbour nodes and a set of users
users—sources of demand outside the control of L-CID
service—a particular processing function e.g. summing two numbers
service list—each node has a service list which contains the set of services which that node is able to offer
service runner—each node has a service runner which maintains the set of services currently being offered by that node, and deals with incoming jobs
task—a demand from a user for an instance of a service to be performed, which supplies the data to be processed e.g. ‘SUM, 3, 4’
request—when L-CID gets a task from a user it creates a request, which will remain in the system until the task is fulfilled. A request has the same information as a task plus the identity of the user who submitted the task. e.g. ‘User A, SUM, 3, 4’
job—an instance of a service to be performed at a particular node's service runner. A job is created when Ag meets Ab (see below). A job has the same information as a request plus the address of the node which will perform the service. e.g. ‘Node X, User A, SUM, 3, 4’
fulfillment—a request is made, a job is run and a processed result returned to the user e.g. the number 7 is returned to the user who requested ‘SUM, 3, 4’
failure—a job is initiated but the result does not return to the user
specificity—every element in L-CID has a specificity and will only interact with other elements of the same specificity. In a preferred embodiment this relates directly to the different types of service (so a task requiring service SUM would result in a L-CID request with specificity SUM (or whatever the chosen system identifier for that service is), resulting in synthesis of Ags with specificity SUM. And the eventual fulfilment of that task depends on interactions among those Ags and Tcells, Bcells and Abs all of specificty SUM to create a job of specificity SUM.

### What is the Advantage of Service Management?

Service Management means the process by which a node decides (or is told) which services it will offer from the set of all possible services.

We imagine that it is more efficient for a node to specialise in a small number of services than to spread itself across a very wide set of services. So a node offering only service A would process requests for that service more than twice as quickly as an otherwise identical node which uses 50% of its resources offering service A and 50% offering service B.

We also expect that there would be some advantage in reducing the distance (in the overlay network) between the request and the node fulfilling that job. This could be because there is some explicit cost (in time or other units) associated with each ‘hop’ taken by the request going out and the fulfilled response coming back. Or it could be that the chance of a job failing increases as the distance increases, perhaps because the node moves within the overlay and can no longer be found or because it has ceased running the correct service type for the job in question.

In addition we expect that in some circumstances a node may incur penalties when it changes the service(s) it offers (time, memory or processor power may be used setting up a new service). So it can be more efficient to keep providing a particular service even if there is a short-lived drop in demand for that service.

L-CID does not necessarily have to be told what the costs or efficiencies of a particular situation are. L-CID will tend to lead the system towards a distribution of services which deals most rapidly with demand. So if inefficiencies cause time delays the system will tend to reduce them where possible (by favouring a more efficient (quicker) service provision).

If the costs are not inherently, manifested by time delay, they must be represented in some other way to L-CID. This could be by translating them into an artificially-introduced delay (i.e. if making a one-hop link costs 100 currency units, then introduce a 100 time unit delay to communications on that link).

### Test Scenario

For system testing and validation we have used a highly simplified version of the above scenario. Other more realistic scenarios are currently being investigated to demonstrate the potential efficiency benefits of L-CID over other methods.

In the simplified scenario we use a network of 10 nodes (numbered 0 to 9) where each node is connected to nodes with numbers +1 or −1 its own. i.e. node 5 is connected to nodes 4 and 6. Node 0 is only connected to node 1. Node 9 is only connected to node 8. Each node has a single user attached. All users generate demand according to the same function on all users in any given simulation run. The function specifies the probability that a new request for a service type will be created in the current timestep. So for example, for a single simulation run we might decide that the probability of a request for service A is 0.01. That would mean that in every timestep, on every node, there is a 1% chance of a new request for service A.

### Mechanism

The nodes have an interaction area within which the elements of the L-CID mechanism can encounter each other. There are 4 types of interacting element in L-CD called ‘Ag’ ‘Ab’ ‘Tcell’ and ‘Bcell’. Very broadly we can imagine the Ags represent requests, the Tcells are the quick to respond elements which can spread word of new demand through the network, Bcells take longer to get going but they are the effectors which influence service provision and Abs act like ‘offers’—telling Ags where to go to get their request fulfilled.

Ag—are L-CID tokens for user requests. An unfulfilled request generates Ags at a certain rate. The Ag includes a pointer to the originating user and a ‘specificity’ (the type of service requested). They are able to move from node to node.

Ab—are L-CID pointers to a running service (NB they are really tokens of a fully active Bcell. For now let us assume that a fully active Bcell equates to a running service). The Ab includes a pointer to the node which was running the service at the time the Ab was created. It also has a specificity (details of the type of job which the service in question can fulfil). They are able to move from node to node.

Tcell—have two states and a specificity. Change state from inactive to active when they encounter an Ag which matches their specificity. They are able to move from node to node.

Bcell—have four states and a specificity. Encountering an Ag which matches their specificity changes them from inactive to alpha or from beta to fully active. Encountering an active Tcell which matches their specificity changes them from inactive to beta or from alpha to fully active. When fully active they influence the local service runner to offer the service corresponding to their specificity. This also triggers creation of Abs.

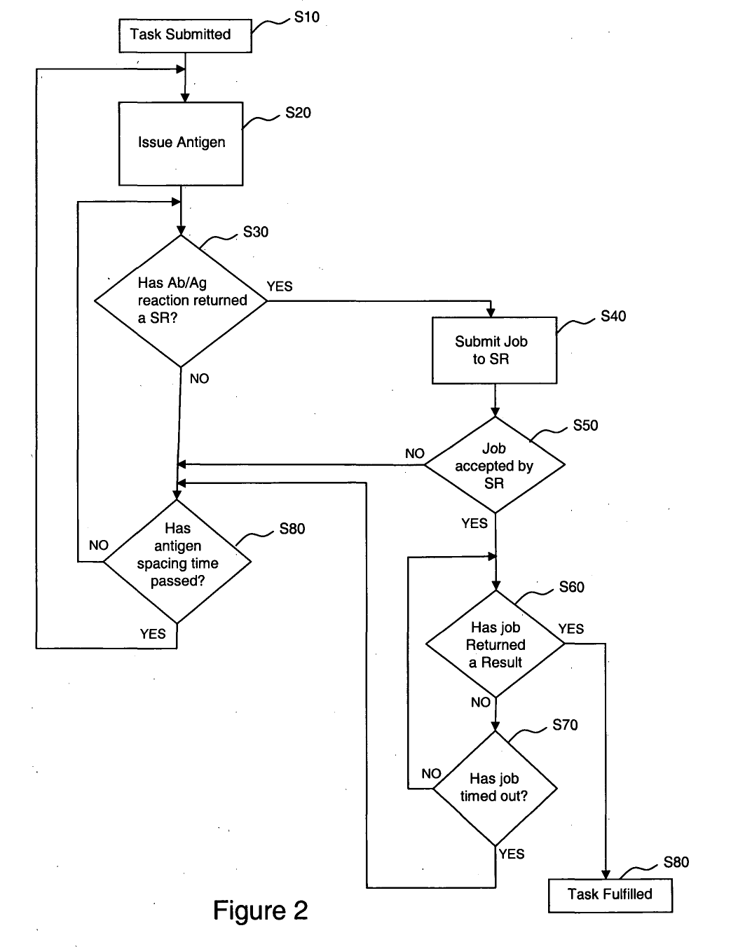

When an Ag encounters an Ab of matching specificity both are destroyed. The information from the Ab about which node was providing the service is passed to the Request that originated the Ag. It is then possible for the Request to attempt fulfillment by sending a Job to the node in question. If successful, the Request will be fulfilled and will clear from the system (so no further Ag will be generated by that Request). If unsuccessful the request is still there and can continue to generate Ag and respond to Ag-Ab pairings. See FIG. 2.

What is Included in L-CID and what is Outside?

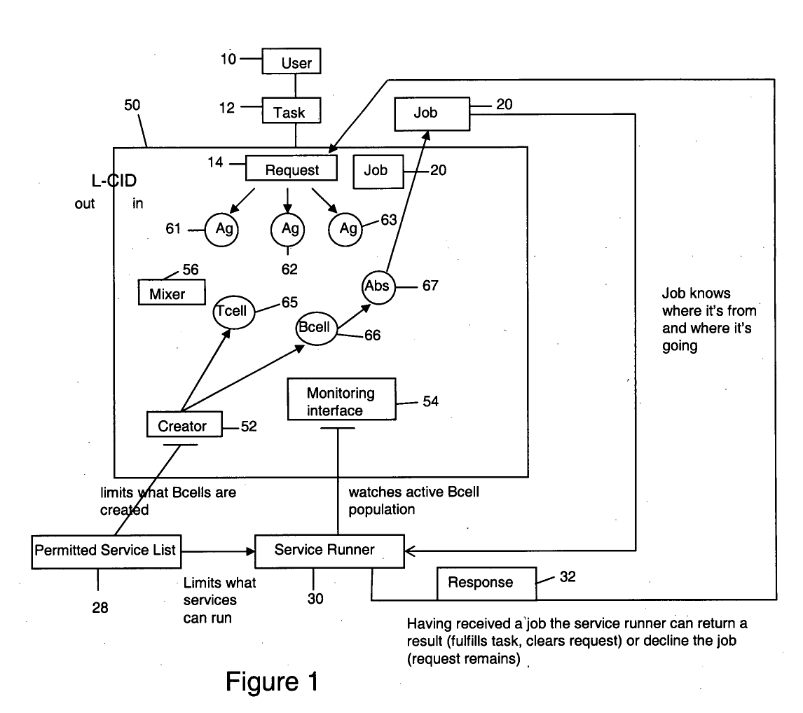

When explaining and understanding L-CID there is a dangerous tendency to conflate the invention with the simulation. To avoid this we offer the following distinction explained with reference to FIG. 1 in which the L-CID mechanism is represented by the box indicated by reference numeral 50—generally, elements 14, 20, 52, 54, 56, 61-63 and 65-67 within the L-CID box 50 are part of the L-CID mechanism whereas the elements 10, 12, 28, 30, 32 which are outside the L-CID box 50 are not part of L-CD; the exception is that a job 20 is part of L-CID but must also exist outside of L-CID in order to be carried out—this is explained in greater detail below.

Users 10 are NOT L-CID. They do not care about L-CID mechanisms or the existence of a network of nodes. They want various tasks to be fulfilled. For example a user 10 might have a set of pairs of numbers and wants each pair summed. Such a user would create a task 12 for each pair and feed these tasks in at the local access point.

Tasks 12 are NOT L-CID. They are created by users.

Requests 14 ARE L-CID. L-CID parses tasks 12 to produce requests 14. In the present embodiment, a very direct ‘parsing’ is used which simply requires that the request 14 holds the identity of the user 10 (so that results can be returned to the right user) and the content of the task 12 (the process to be performed and the data to be processed).

The request 14 generates Ag cells 61,62,63 which interact with Tcells 65, Bcells 66 and Ab's 67. All of these elements are part of L-CID. The interactions among these elements are a key part of the L-CID mechanism of the present embodiment.

The request 14 receives a response or result 32 returned by a service runner 30 in response to a Job 20 (see below). If fulfilled the request 14 terminates. If not fulfilled (because, for example, the service runner has rejected the Job) the request 14 remains and can continue to create Ags 61,62,63.

Various rules for Ag 61,62,63 creation by the Request 14 can be used, for example a simple constant rate of production which ceases when the Request terminates. Another example could be: an initial burst of Ag creation followed by a constant rate of production with creation suspended for a time after a Job 20 is despatched and resumed after a period if there is no response to the Job 20.

When Ags 61,62,63 encounter Abs 67 of matching specificity a Job 20 is created. Jobs 20 are considered to be part of the L-CID mechanism. They get the address of a node from the Ab 67 and the identity of a user 10, the service required and the data to be processed from the Ag/Request 61,62,63/14.

This job 20 then leaves the L-CID system 50 and is routed to the destination node (which may be the local node whose mixer 56 is running this L-CID mixing area or may be a remote node somewhere else in the network) by whatever communication protocol is used in the network.

The Service Runner 30 is not considered part of the L-CID mechanism 50. This is the part of the node which runs currently active services and deals with incoming jobs. When a new job arrives the service runner 30 can accept it or reject it. If and when it completes a job it returns the result to the point of origin using whatever network communication protocols are in force.

The Service Runner 30 also encapsulates some decision-making function, allowing it to autonomously decide to deactivate existing services and activate new ones. This is done with reference to two other components:
the Permitted Services List 28, which is a ‘white list’ of all the services which the Service runner 30 at that node could choose to run. It is possible that entries in this list could have weightings or other information which would affect the circumstances under which the Service Runner would activate/deactivate those services.
The Monitoring Interface 54, which is part of L-CID and is designed to display the internal dynamics of L-CID to non-L-CID observers. The monitoring Interface could faithfully display exact active Bcell numbers or it could apply its own threshold (e.g. it would not, inform the Service Runner of the existence of active Bcells of a particular specificity until they represented more than 5% of the active Bcell population):

It should be clear, then, that the Service Runner 30 is using L-CID as one of the factors influencing its decision-making. It is acting in accordance with externally-set policies which are outside the control of L-CID. Through the Monitoring Interface 54 it is also possible for L-CID to introduce its own set of policies.

We imagine that the external policies would relate to high level system requirements and service level agreements (e.g. it might be a requirement of the system that every node is always running service X regardless of demand. In such a case the level of active Bcells of specificity X would be irrelevant to the service runner 30. The monitoring interface 54 would faithfully report the presence or absence of such cells but the service runner 30 would keep running service X anyway). And we imagine that the internal L-CID policies would relate to tuning the system to give effective dynamics (e.g. deciding that active Bcell numbers at less than 5% of the total Bcell population should not be reported because this is ‘noise’).

However it would be quite possible to use L-CID Monitoring Interface policies to exert gross control rather than tuning (e.g. by never reporting the level of active Bcells of specificity Y)

The Creator 52 is part of L-CID and makes new Tcells 65 and Bcells 66 of random specificity, but where the specificity of Bcells is limited by the local service list 28. In every time-step there is a probability of creating a Tcell 65, and if one is created, then, in the present embodiment, it will be of random specificity chosen with a uniform distribution across the full range of specificities.

There is also a probability of creating a Bcell 66, and if one is created, then, in the present embodiment, it will be of random specificity chosen with a uniform distribution across the set of specificities in the local Permitted Services List.

The Mixer 56 is part of L-CID and causes interactions to take place by selecting L-CID elements and applying the interaction rules. In the present embodiment this is done by choosing two elements at random. In most cases the specificities do not match so most pairings do not result in interactions. Alternative ways of choosing elements could be used which preserve the probabilistic nature of encounters but may be more efficient.

The Monitoring Interface 54 is a ‘window’ into the internal state of the L-CID mechanism 50. At its simplest it could be a list of the numbers of active B cells of each specificity. The service runner 30 observes L-CID state via this monitoring interface 54. As noted above, this monitoring interface is an opportunity for L-CID to ‘distort’ the portrayal of its internal state, if that is deemed beneficial.

FIG. 1 shows a single node in the network. The central square 50 shows the L-CID dynamical system. The users 10 (who attach to nodes and demand services) and the service runners 30 (which fulfil service demands) are not within L-CID. Because demand is fed into L-CID and perturbs the dynamics, it is useful for the service runner 30 to observe (or be informed of) the activity in L-CID when it decides what services it should currently be offering.

Note that the Permitted Service List 28 (which is not part of L-CID) is used to limit the set of services available to the service runner 30 (the node cannot offer services not in its list) and limits the creation of Bcells and, in a preferred embodiment, Tcells (L-CID at this node will not create any Bcells for services which the local node cannot offer).

To be clear it must be understood that every node has a permitted services list which places limits only on that local node so for example in a network offering a full alphabet (A-Z) of services the Permitted Service List at one node might be ‘A,B,C’ meaning that L-CID at that node can only create Bcells (and in preferred embodiment Tcells) of specificity A, B or C. Another node in the same network could have the Permitted Service List ‘X,Y,Z’ and would only be able to create Bcells (and in preferred embodiment Tcells) of specificity X, Y or Z.

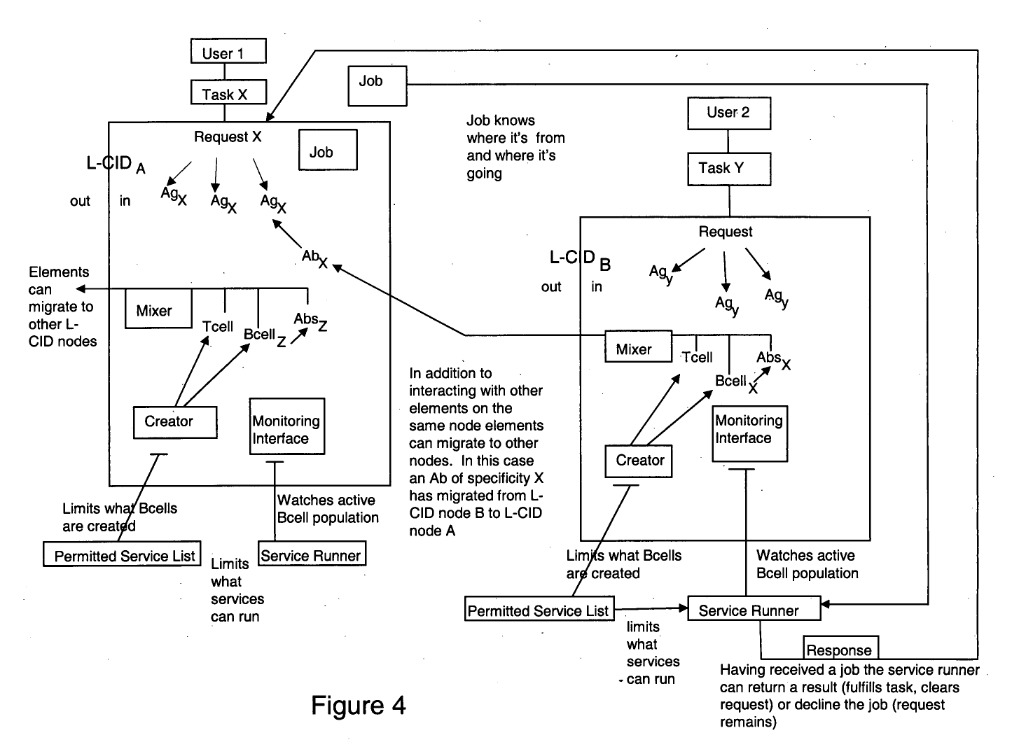

When an Ag 61,62,63 encounters a matching Ab 67, a Job 20 is created which is despatched to the service runner 30 of whichever node address the Ab 67 in question supplies. In FIG. 1 this happens to be the local node itself, and hence the Job 20 is sent to the local service runner 30. (See FIG. 4 for a situation in which the Job is sent to a remote service runner). The service runner in question can then do the processing required and return a result to the originating request (which passes the result up to the task and deletes itself from the system). Or the service runner may decline the job (in which case the request lives on). Or the service runner may not respond at all (perhaps because it is no longer in the network, although this type of failure may be dealt with by whatever communications protocol is in use).

FIG. 2 shows a flowchart for the lifecycle of a Request (in FIG. 2 ‘Antigen’ is the same as ‘Ag’ and ‘SR’ is short for ‘Service Runner’). A Request is created when a user submits a task (S10). It issues (S20) Ags according to the scheme in force (e.g. at a constant rate). When one of its Ags encounters a matching Ab the Request creates a Job which is sent to the service runner address provided by the Ab. (i.e. at step S30 it is determined if an Ab/Ag reaction has resulted in the creation of job to be sent to a specific Service Runner (SR)—if so the method proceeds to step S40 in which the Job is sent to the identified Service Runner, otherwise, the method proceeds to step S80 described below). While waiting for a response the Request changes its behaviour by suspending Ag production. In the event that the Job is rejected by the target service runner (i.e. if it is determined in step S50 that the job has not been accepted then the method again proceeds to step S80, otherwise the method proceeds to step S60), or if no response is received after a set time interval, the Request reverts to its behaviour of creating Ags (i.e. at step S60 it is determined if the job has returned a result and if not the method proceeds to step S70 where it is determined if the job has timed out, if not the method loops back to step S60 to await either a result being detected at step S60 or the job timing out at step S70—if it is detected that the job has timed out at step S70 the method proceeds to step S80—in step S80 it is determined if the antigen spacing time has passed, if not the method loops back to step S30, if at step S80 it is determined that the antigen spacing time has now passed, then the method loops back to step S20 in which a new antigen is issued). If a result of a job is detected (at step S60) then the task is fulfilled and at step S80 the Request is destroyed and then the method ends.

### Mechanistic Detail and Parameter Setting

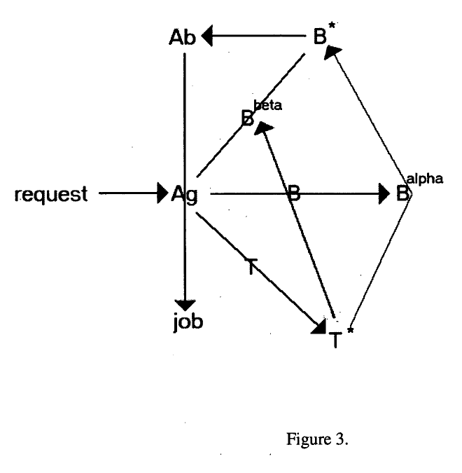

The ‘rules’ of interactions have already been stated above. FIG. 3 shows the interactions in diagrammatic form. Note that B* is used in the figure to denote a fully activated Bcell and T* is used to denote an active Tcell.
Requests create Ags which can interact with Tcells to make active Tcells and with Bcells to make alpha-activated Bcells.
Ags can also interact with beta-activated Bcells to make fully-active B cells.
Active Tcells can interact with alpha-activated Bcells to make fully-active Bcells.
Fully active Bcells create Abs.
Active Tcells can interact with inactive Bcells to make beta-activated Bcells.
Abs can interact with Ags to create jobs (and in so doing the Ab and Ag are destroyed).
All of these interactions only occur between elements of matching specificity.

The two other main parts of the mechanism which we have not yet described properly are the birth/death of elements and the process of element interaction.

### Birth/Death/Diffusion (Diffusion Means Movement to One of the (Randomly Chosen) One-Hop Neighbours of the Current Node)

Request: one created per user task. Dies only when fulfilled
Ags: created by requests. For example Ags could be created at a constant rate except when a request is waiting for a job to report ‘fulfilled’ ‘failed’ or to time out. Dies when meets matching Ab (after creating job)
Abs: created by fully-active Bcells at a constant rate (and with specificity matching creator cell). High death rate. Dies after meeting matching Ag (after creating job).
Tcells: created at constant rate with random specificity. In a more complex embodiment the rate of Tcell creation can be reduced as the number of existing Tcells increases (negative feedback). In a preferred embodiment the specificities of Tcells created at a node are limited to specificities included on the Permitted Services List at that node.
Bcells: created at constant rate with random specificity (but only from specificities included on the Permitted Services List at the local node). In a more complex embodiment the rate of Bcell creation can be reduced as the number of existing Bcells increases (negative feedback)
Job: one created per Ag/Ab matching interaction. Dies when reports fulfilled/failed to request

### The Process of Interacting

Within L-CID, in every timestep, on every node, two elements are chosen at random from the population. They are tested to see if they will a) die or (if not) b) diffuse to a different node.

If they are both still on the same node they can interact according to the rules above.

Note: there may be more computationally efficient ways of doing this which still preserve the desired probabilistic nature of encounters.

### A Network of Nodes

Finally it is important to remember that L-CID is intended to function in a network of connected nodes. FIG. 4 shows how requests generated at L-CID node A can be fulfilled by the service runner at L-CID node B.

User 1 demands Task X. This generates a Request X at L-CID node A. The service which can fulfil the Request X may not be running at node A (it may not even be in the permitted service list for node A).

Elements can migrate from one node to another by ‘Diffusion’ (see above). In the situation shown in FIG. 4 an Ab of specificity X has diffused from node B to node A.

Once on node A the Ab specificity X can interact with the Ag specificity X to create a Job. Thanks to the origin information carried by the Ab, the Job knows which node it should go to.

When the job reaches the node it requests the appropriate service and the service runner at node B responds.

### CONCLUSION

We have described a system which generates its own internal dynamics using demand from users as the main input. Although the internal workings of L-CID seem complicated, the aim is simply to provide an output via the monitoring interface which can be used to influence service provision. The main factor in the output is the number of fully active Bcells.

So, crudely, Ags of a certain specificity are created by demands of that specificity. At any time the number of fully active Bcells of a given specificity will influence the services running on the node.

The internal dynamics have to be complicated because we don't want active Bcells (and hence running services) to follow every transient peak and trough of local and remote demand. Hence we introduce the double activation idea from the adaptive immune system: Bcells must encounter a matching Ag and a matching active Tcell before they are fully active.

1. A method of operating a data network comprising a plurality of interconnected nodes each of which is operable to perform one or more services upon receiving a suitable request for a service, whereby one or more user devices connected to the network can issue requests for a service to be carried out by a node or nodes within the network, the method comprising: operating a virtual mechanism in which a plurality of different types of elements are represented, each element obeying a set of rules associated with the respective type of the element, the respective set of rules specifying how the element behaves, wherein each element has a location property which may be correlated to one or more nodes or node locations, the method further comprising analysing the virtual mechanism and selecting one or more services to be offered by each node in the network based on the analysis of the virtual mechanism.

2. A method according to claim 1 wherein the virtual mechanism has a plurality of virtual locations at which an element may be located, and wherein each virtual location is associated with a node or nodes, and each node determines which services to offer based on an analysis of the elements within the virtual location or locations associated with the respective node.

3. A method according to claim 2 wherein the virtual mechanism is run in a distributed manner by the nodes, each node running an environment for hosting a virtual location local to it.

4. A method according to claim 1 wherein the selection of individual service requests to fulfil is additionally based on an analysis of the virtual mechanism.

5. A data network comprising a plurality of interconnected nodes each of which is operable to perform one or more services upon receiving a suitable request originating from a user device connected to the network, the network further comprising an environment for running a virtual mechanism in which a plurality of different types of elements are represented, each element obeying a set of probabilistic rules associated with the respective type of the element, the respective set of rules specifying how the element behaves, wherein each element has a location property which may be correlated to one or more nodes or node locations, and wherein the network further includes a virtual mechanism analyser for analysing the virtual mechanism and determining, based on the analysis, the services to be offered by each node in the network.

6. A data network according to claim 5 wherein the environment for running the virtual mechanism is provided by the nodes themselves, in a distributed manner, in which each node runs a local portion of the overall environment.

7. A data network according to claim 6 wherein each node running a local environment portion includes interface means for permitting elements to be migrated from one local portion of the environment to another.

8. A computer program or suite of programs for causing the method of claim 1 to be carried out during execution of the program or programs.

9. Carrier means carrying the program or programs of claim 8.
